(19) United States
(12) Patent Application Publication
(10) Pub. No.: US 2010/0333120 A1
(43) Pub. Date: Dec. 30, 2010

(54) Tray of an Optical Disc Drive

(75) Inventors: Lin Che-Ching, Taipei City (TW); Lee Yuan-Yu, Taipei City (TW); Chuang Yao Nien, Taipei City (TW); Chung-Chou Fan, Taipei City (TW); Shih-Lin Yeh, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/492,341

(22) Filed: Jun. 26, 2009

(51) Int. Cl. G11B 17/03

(52) U.S. Cl. 720/603; G9B/17.009

(57) ABSTRACT

A tray of an optical disc drive for loading an optical disc in and out of the optical disc drive includes a depression for disposing the optical disc, a hollow space for providing a space for an optical pickup to access data while the optical pickup moves along a radial direction of the optical disc, a depressed portion formed at the middle portion of a rear end of the tray, and a reinforcement means formed of rigid material and disposed at the depressed portion for enhancing rigidity of the tray. The depression and depressed portion are monolithically formed.

### BACKGROUND OF THE INVENTION

1. Field of the Invention

The present invention relates to a tray of an optical disc drive, and more particularly, to a reinforced tray of an optical disc drive.

2. Description of the Prior Art

Optical discs and optical disc drives are gaining popularity nowadays. Users can use optical discs and optical disc drives to access audio and video data stored in the optical discs.

Please refer to FIG. 1. FIG. 1 shows a component diagram of a prior art optical disc drive. The optical disc drive comprises a chassis 1, a tray 2, a cover 3, a spindle motor 11 disposed on the chassis 1, a magnetic turntable 12 for attracting a clamping device 31 disposed on the cover 3, an optical pickup 13 disposed beside the spindle motor 11 and slidable on two guiding rods 14 for accessing data stored on an optical disc. When the tray 2 is slid into a slot of the optical disc drive, the optical disc on the tray 2 is clamped by the turntable 12 and the clamping device 31. The spindle motor 11 then rotates the optical disc for the optical pickup 13 to access the data stored on the optical disc.

The tray 2 is used to carry the optical disc to move in and out of the slot. The tray 2 has a big depression 21 for disposing a 12 cm-disc, a small depression 22 for disposing an 8 cm-disc, and a hollow space 23 for providing a space for the optical pickup 13 to access data while the optical pickup 13 moves along a radial direction of the optical disc, so as to avoid blocking the light beam emitted by the optical pickup 13. The middle portion of a rear end of the tray 2 has a depressed portion 24 to dodge the turntable 12 and the clamping device 31 when the tray 2 is slid in and out of the optical disc drive. The big depression 21, small depression 22 and the depressed portion 24 are monolithically formed.

Please refer to FIGS. 2 and 3. FIG. 2 is a cross sectional view of the optical disc drive in FIG. 1. FIG. 3 is a magnified diagram of the portion B in FIG. 2. When an optical disc D is to be carried out of the slot, the spindle motor 11 and the optical pickup 13 will descend to separate the turntable 12 from the clamping device 31, then the tray 2 can be slid out of the slot. After the tray 2 is slid out of the slot, the depressed portion 24 will pass through the space between the turntable 12 and the clamping device 31. As shown in FIG. 3, because the depressed portion 24 has a smaller thickness, it would not bump into the turntable 12 or the clamping device 31. Likewise, when the tray 2 is slid into the slot of the optical disc drive, the tray 2 would not bump into the turntable 12 or the clamping device 31.

Thus the thin design of depressed portion 24 is to prevent the tray 2 from bumping into the turntable 12 or the clamping device 31 when the tray 2 is slide in or out of the slot of the optical disc drive. However when the optical disc drive is operating, the rotation of the spindle motor 11 and the laser beam emitted by the optical pickup 13 will cause the internal temperature of the optical disc drive to increase. Further, the thickness of the depressed portion 24 is smaller than other portions of the tray 2, thus the depressed portion 24 may be deformed during the operation of the optical disc drive. If the depressed portion 24 is deformed, when the tray 2 is slid in or out of the slot of the optical disc drive, the depressed portion 24 may bump into the turntable 12 or the clamping device 31 causing unexpected response of the optical disc drive and reducing the reliability of the optical disc drive.

Therefore, current research is directed to the improved structure of the tray to enable the tray resistible of the impacts of temperature changes or other factors during the operation of the optical disc drive.

### SUMMARY OF THE INVENTION

It is therefore an object of the present invention to provide a reinforced tray of an optical disc drive.

The present invention provides a tray of an optical disc drive for loading an optical disc in and out of the optical disc drive. The tray comprises a depression for disposing the optical disc; a hollow space for providing a space for an optical pickup to access data while the optical pickup moves along a radial direction of the optical disc; a depressed portion formed at the middle portion of a rear end of the tray; and a reinforcement means formed of rigid material and disposed at the depressed portion for enhancing rigidity of the tray.

Adding a rigid reinforcement means at the depressed portion will resist deformation of the depressed portion and reduce other external impacts due to the temperature increase during the operation of the optical disc drive, thereby increasing the reliability of the optical disc drive.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a component diagram of a prior art optical disc drive.

FIG. 2 is a cross sectional view of the optical disc drive in FIG. 1.

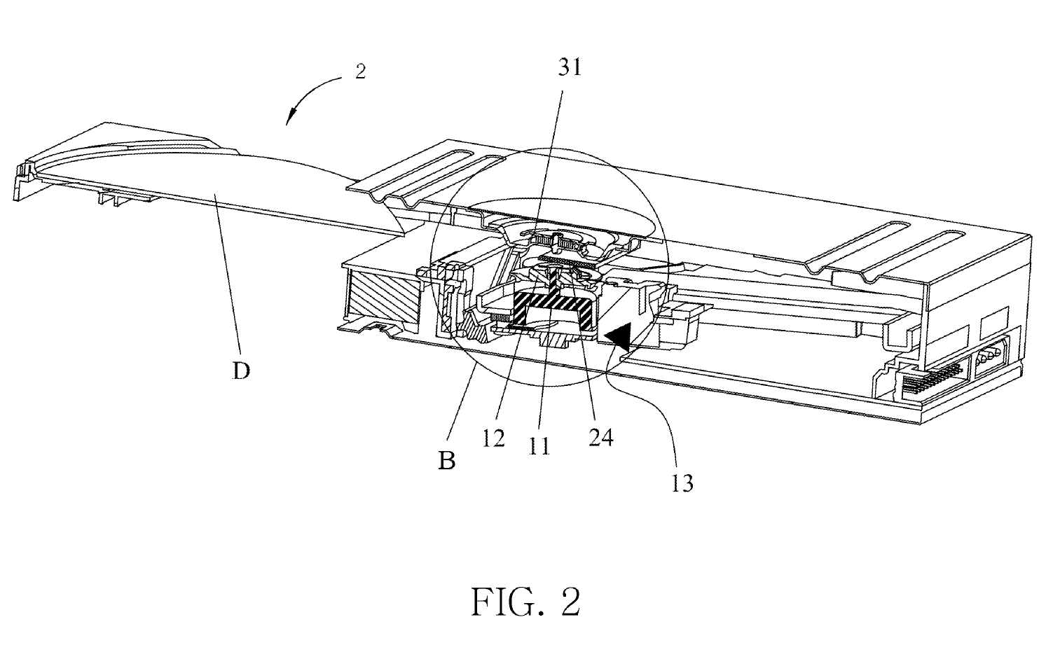

FIG. 3 is a magnified diagram of the portion B in FIG. 2.

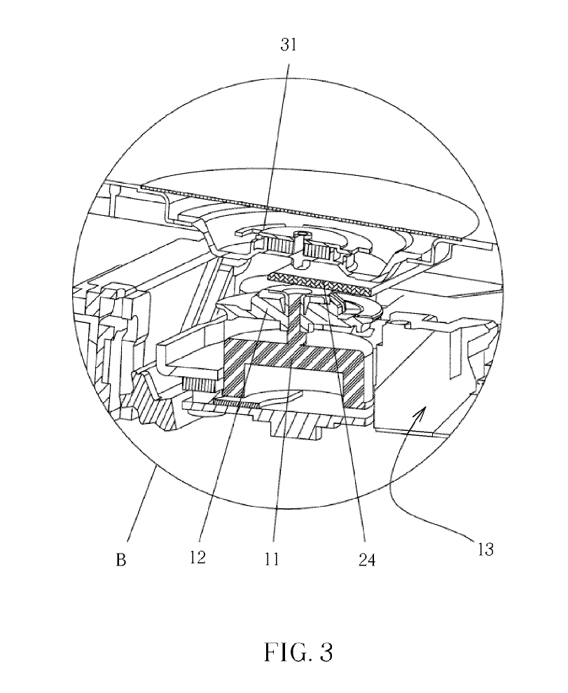

FIG. 4 is a component diagram of a tray of an optical disc drive according to a first embodiment of the present invention.

FIG. 5 is a perspective view of the tray in FIG. 4.

FIG. 6 is a component diagram of a tray of an optical disc drive according to a second embodiment of the present invention.

FIG. 7 is a perspective view of the tray in FIG. 6.

FIG. 8 is a component diagram of a tray of an optical disc drive according to a third embodiment of the present invention.

FIG. 9 is a perspective view of the tray in FIG. 8.

FIG. 10 is a component diagram of a tray of an optical disc drive according to a fourth embodiment of the present invention.

### DETAILED DESCRIPTION

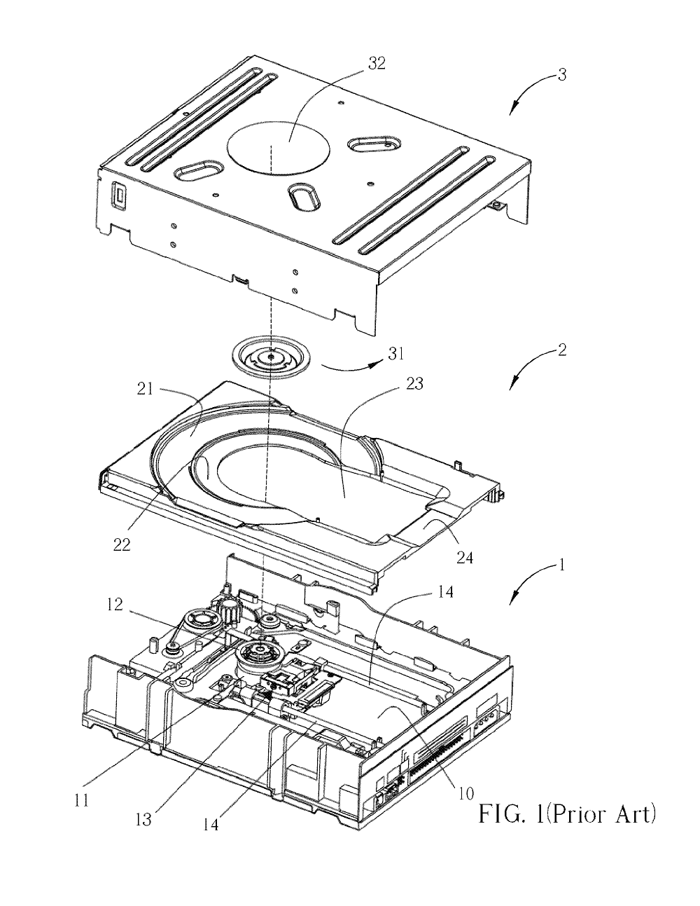

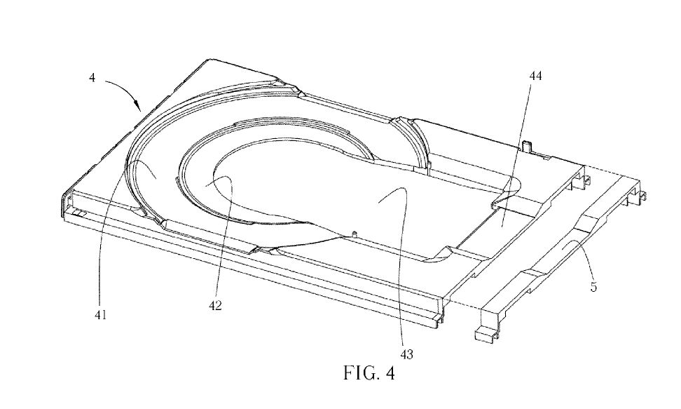

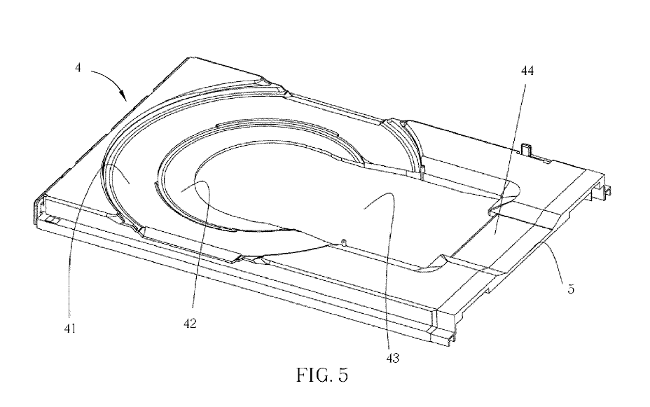

Please refer to FIGS. 1, 4 and 5. FIG. 4 is a component diagram of a tray of an optical disc drive according to a first embodiment of the present invention. FIG. 5 is a perspective view of the tray in FIG. 4. The tray 4 of the first embodiment of the present invention has a big depression 41 for disposing a 12 cm-disc, a small depression 42 for disposing an 8 cm-disc, and a hollow space 43 for providing a space for the optical pickup 13 to access data while the optical pickup 13 moves along a radial direction of the optical disc, so as to avoid blocking the light beam emitted by the optical pickup 13. The middle portion of a rear end of the tray 4 has a depressed portion 44 to dodge the turntable 12 and the clamping device 31 when the tray 4 is slid in and out of the optical disc drive. The big depression 41, small depression 42 and the depressed portion 44 are monolithically formed by material such as plastic.

A reinforcement piece 5 formed of rigid material is attached to the rear end of the tray 4. The shape and thickness of the reinforcement piece 5 matches those of the rear end of the tray 4. And the reinforcement piece 5 can be attached to the rear end of the tray 4 with an adhesive, screws or other means. After the reinforcement piece 5 is combined with the tray 4, the combined structure is shown in FIG. 5. Because the reinforcement piece 5 is formed of rigid material, its material density is greater than that of the tray 4, thus can enhance the rigidity of the rear end of the tray 4. The reinforcement piece 5 can prevent deformation of the depressed portion 44 caused by the increased temperature due to the operation of the optical disc drive or other external factors, increasing the reliability of the optical disc drive.

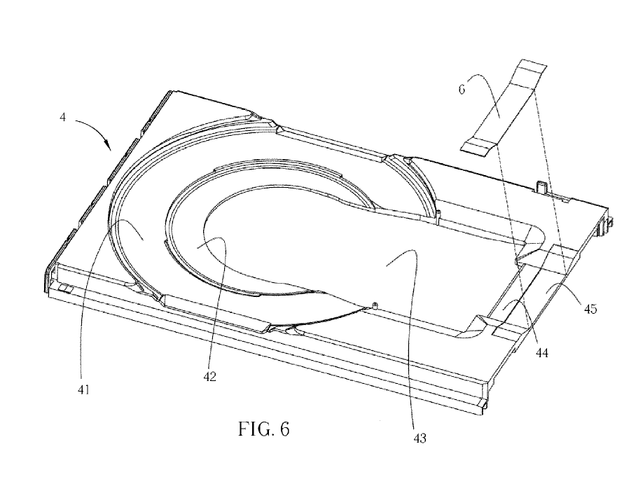

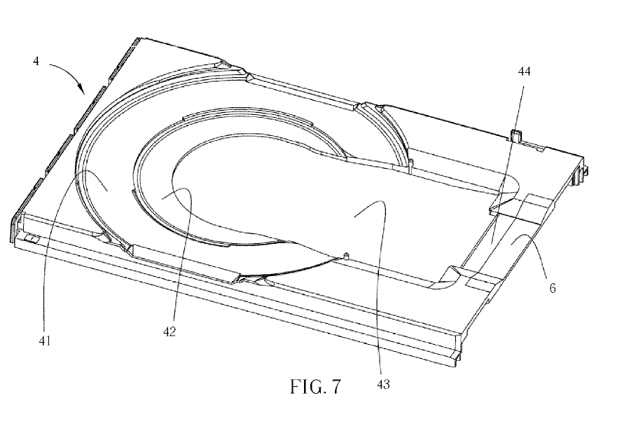

Please refer to FIGS. 6 and 7. FIG. 6 is a component diagram of a tray of an optical disc drive according to a second embodiment of the present invention. FIG. 7 is a perspective view of the tray in FIG. 6. The tray 4 of the second embodiment of the present invention has a big depression 41 for disposing a 12 cm-disc, a small depression 42 for disposing an 8 cm-disc, and a hollow space 43 for providing a space for the optical pickup 13 to access data while the optical pickup 13 moves along a radial direction of the optical disc, so as to avoid blocking the light beam emitted by the optical pickup 13. The middle portion of a rear end of the tray 4 has a depressed portion 44 to dodge the turntable 12 and the clamping device 31 when the tray 4 is slid in and out of the optical disc drive. The big depression 41, small depression 42 and the depressed portion 44 are monolithically formed by material such as plastic.

A reinforcement piece 6 formed of rigid material is attached to the rear end of the tray 4. The reinforcement piece 6 is a thin rigid piece and is disposed on a depressed section 45 of the depressed portion 44. The reinforcement piece 6 is adhered or locked onto the depressed section 45 as shown in FIG. 7. The function of the reinforcement piece 6 is the same as the reinforcement piece 5 and thus will not be reiterated herein.

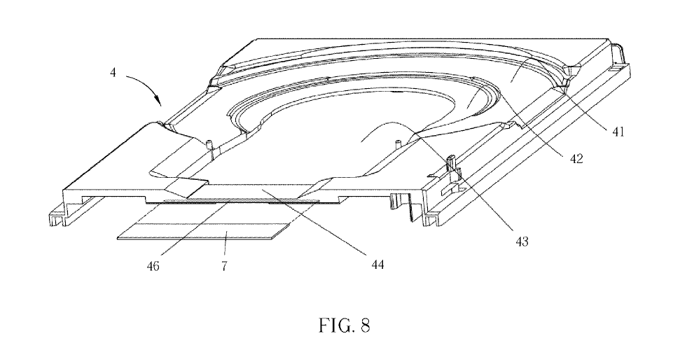

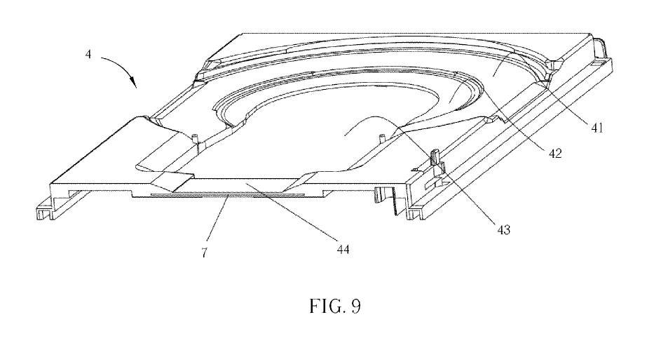

Please refer to FIGS. 8 and 9. FIG. 8 is a component diagram of a tray of an optical disc drive according to a third embodiment of the present invention. FIG. 9 is a perspective view of the tray in FIG. 8. The tray 4 of the third embodiment of the present invention has a big depression 41 for disposing a 12 cm-disc, a small depression 42 for disposing an 8 cm-disc, and a hollow space 43 for providing a space for the optical pickup 13 to access data while the optical pickup 13 moves along a radial direction of the optical disc, so as to avoid blocking the light beam emitted by the optical pickup 13. The middle portion of a rear end of the tray 4 has a depressed portion 44 to dodge the turntable 12 and the clamping device 31 when the tray 4 is slid in and out of the optical disc drive. The big depression 41, small depression 42 and the depressed portion 44 are monolithically formed by material such as plastic.

An opening 46 for disposing a reinforcement piece 7 formed of rigid material is formed at the depressed portion 44. The reinforcement piece 7 can be inserted into the opening 46. The combined structure of the reinforcement piece 7 and the tray 4 is as shown in FIG. 9. The function of the reinforcement piece 7 is the same as the reinforcement piece 5 and thus will not be reiterated herein.

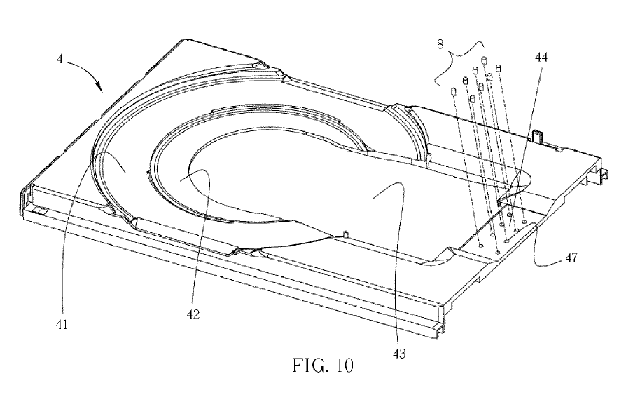

Please refer to FIG. 10. FIG. 10 is a component diagram of a tray of an optical disc drive according to a fourth embodiment of the present invention. The tray 4 of the fourth embodiment of the present invention has a big depression 41 for disposing a 12 cm-disc, a small depression 42 for disposing an 8 cm-disc, and a hollow space 43 for providing a space for the optical pickup 13 to access data while the optical pickup 13 moves along a radial direction of the optical disc, so as to avoid blocking the light beam emitted by the optical pickup 13. The middle portion of a rear end of the tray 4 has a depressed portion 44 to dodge the turntable 12 and the clamping device 31 when the tray 4 is slid in and out of the optical disc drive. The big depression 41, small depression 42 and the depressed portion 44 are monolithically formed by material such as plastic.

The depressed portion 44 is formed with a plurality of holes 47. A plurality of reinforcement stubs 8 are disposed in the plurality of holes 47. The reinforcement stubs 8 are adhered or locked to the holes 47 after inserted to the holes 47. The function of the reinforcement stubs 8 is the same as the reinforcement piece 5 and thus will not be reiterated herein.

Besides using the reinforcement piece 5, 6, 7 or reinforcement stubs 8, powder formed of rigid material can be added to the depressed portion 44 while forming the tray 4. Thus when the tray 4 is formed, the rigidity of the depressed portion 44 can be enhanced by the powder to prevent deformation of the depressed portion 44 caused by the increased temperature due to the operation of the optical disc drive or other external factors, increasing the reliability of the optical disc drive.

By adding a rigid reinforcement piece at a fragile end portion of the tray, the rigidity of the tray can be increased, thus reducing impacts of temperature changes or other external factors. Moreover, since overall thickness of the depressed portion 44 has not been increased, the depressed portion 44 will not bump into the turntable 12 or the clamping device 31.

Furthermore, the reinforcement piece or stubs can be planted, attached, adhered, screwed or affixed by any other means to the depressed portion 44 to reinforce the structure of the tray of the optical disc drive.

Those skilled in the art will readily observe that numerous modifications and alterations of the device and method may be made while retaining the teachings of the invention.

What is claimed is:

1. A tray of an optical disc drive for loading an optical disc in and out of the optical disc drive comprising:
a depression for disposing the optical disc;
a hollow space for providing a space for an optical pickup to access data while the optical pickup moves along a radial direction of the optical disc;
a depressed portion formed at the middle portion of a rear end of the tray, wherein the depression and depressed portion are monolithically formed; and
a reinforcement means formed of rigid material and disposed at the depressed portion for enhancing rigidity of the tray.

2. The tray of claim 1 wherein the reinforcement means is attached to a rear end of the depressed portion.

3. The tray of claim 1 wherein the depressed portion has an opening for disposing the reinforcement means.

4. The tray of claim 1 wherein the reinforcement means is powder added to the depressed portion when forming the tray.

5. The tray of claim 1 wherein the depressed portion has a plurality of holes for disposing the reinforcement means.
